(19) United States
(12) Patent Application Publication
(10) Pub. No.: US 2008/0142646 A1
(43) Pub. Date: Jun. 19, 2008

(54) Wiring clip

(75) Inventors: Joey D. Magno, Cordova, TN (US); Ian Rubin de la Borbolla, Memphis, TN (US); Cong Thanh Dinh, Collierville, TN (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 12/002,150

(22) Filed: Dec. 14, 2007

Related U.S. Application Data
(60) Provisional application No. 60/875,202, filed on Dec. 15, 2006.

(51) Int. Cl. F16L 3/08

(52) U.S. Cl. 248/65

(57) ABSTRACT

A wiring clip secures electrical wires and cables to a structural stud. The clip includes a mounting member for mounting to the stud. A pair of elongate fingers extend from the mounting member. The fingers are arranged in spaced apart fashion to define a channel therebetween for accommodating a cable. The fingers are bendable at portions thereof to secure the cable in the channel defined between the fingers.

### CROSS-REFERENCE TO RELATED APPLICATION

This application claims priority to U.S. Provisional Patent Application No. 60/875,202, filed on Dec. 15, 2006, herein incorporated by reference.

### FIELD OF THE INVENTION

The present invention relates generally to a wiring clip for securing electrical wires and cables to building studs. More particularly, the present invention relates to a wiring clip which supports wires and cables a requisite distance from the face of the stud.

### BACKGROUND OF THE INVENTION

The use of wiring clips to secure wires and cables to building studs have long been known. In building construction using dry wall, also referred to as wall board, these panels are installed over studs. These studs may be wood or metal. Before the wall boards are applied to the studs, the internal wiring which, for example, is used to run power to switches and receptacles is typically installed. Thereafter, the wall board is applied to the studs to enclose the wall.

In order to prevent damage to the wiring behind the wall board during installation of the wall board, the wires must be placed a requisite distance from the wall board. This is to prevent inadvertent contact with securement hardware such as nails or screws which are used to secure the wall board to the studs or which are used to secure other devices to the wall board intermediate the studs.

The art has seen a wide variety of clips which support wires and cables a requisite distance from the base of the stud. For example, U.S. Pat. No. 5,141,185 shows a wire clip having an L-shaped securement portion of which provides a cable support surface spaced a requisite distance from the front face of the stud. The wiring clip of the '185 patent is a metallic member having a bendable arm which may be bent around the wires and cables to secure the wires between the bendable arm and the cable support surface. However, it has been found that the clip shown in the '185 is difficult to use inasmuch as the bendable arm must be folded around the cables and the end of the bendable arm must be then inserted through an opening in the cable support surface to fix the cables on the support surface of the clip.

It is, therefore, desirable to provide a cable support clip which supports wires and cables at a requisite distance from the base of a stud yet which is easy to use.

### SUMMARY OF THE INVENTION

The present invention provides a clip for supporting electrical wires to a stud. The clip includes an elongate metallic body having a mounting member at one end for attachment to the stud. A pair of elongate fingers extend outwardly from the mounting member. The fingers define a channel therebetween for accommodating the wire and cable. The fingers have end extents which are twistable about one another to secure the wires in the channels.

In one embodiment, the mounting member of the body includes an L-shaped bracket having a first portion for engagement over the face of the stud and a second portion extending perpendicularly thereto along the side of the stud. The second portion extends a requisite distance from the face of the stud. Fingers extend perpendicularly outward from the second portion. The fingers may also be placed in separate planes so as to define the channel allowing for ease of insertion of the wires thereinto.

The distal ends of the fingers may be twisted to secure the wires therein.

In a further embodiment of the present invention, a wiring clip includes an L-shaped base for mounting to a stud. A pair of spaced apart bendable fingers extend from the base. The fingers define a channel therebetween for supporting a wire therein. The fingers are offset so that the bendable fingers can be bent about the wire supported within the channel.

In a preferred embodiment of the present invention, the wiring clip is integrally formed from a elongate metallic body having a mounting member at one end for attachment to a stud and a pair of generally parallel fingers extending outwardly therefrom. The fingers define a channel therebetween for accommodating the cable. The fingers include distal end extends which may be placed in mutual engagement to secure the cable in the channel. The end extent of one of the fingers includes a deformable extending tab for engagement with the end extent of the other finger. The end extent of the other finger may include a slot for receiving the deformable extending tab therein.

### BRIEF DESCRIPTION OF THE DRAWINGS

FIG. 1 is a front perspective view of the wire clip of the present invention.

FIG. 2 is a rear perspective view of the wire clip of FIG. 1.

FIG. 3 shows the wiring clip of FIG. 1 attached to a metal stud.

FIG. 4 shows the wiring clip of FIG. 3 securing an electrical cable to the stud.

FIG. 5 is a perspective showing of an alternate embodiment of the present invention useful for supporting armored cable conduit to a metal stud.

FIGS. 6-8 show the embodiment of the wiring clip of FIG. 5 in top side and perspective view respectively.

FIG. 9 is a perspective showing of a wiring clip of FIG. 5 with the ends twisted in use.

FIGS. 10 and 11 are perspective showings of the clip of FIG. 5 used to attached armored cable to a metal stud.

FIGS. 12 and 13 are perspective showings of a preferred embodiment of the wiring clip of the present invention.

FIGS. 14, 15 and 16 are bottom, side and top elevational showings of the wiring clip of FIGS. 12 and 13.

FIGS. 17 and 18 show further alternative embodiments of the clip of the present invention.

### DETAILED DESCRIPTION OF THE PREFERRED EMBODIMENT

The present invention provides a clip which may be attached to a stud during building construction and which provides for the support of electrical wires and cables at a safe distance away from the face of the stud to prevent the wires and cables from being pierced by securement hardware such as nails and screws during the installation of wall board to the stud.

The present invention may be used to support cables, wires, insulated conductors, as well as conduit including armored cable conduit. In some instances, local or national codes require that armored cable be supported closely adjacent the box.

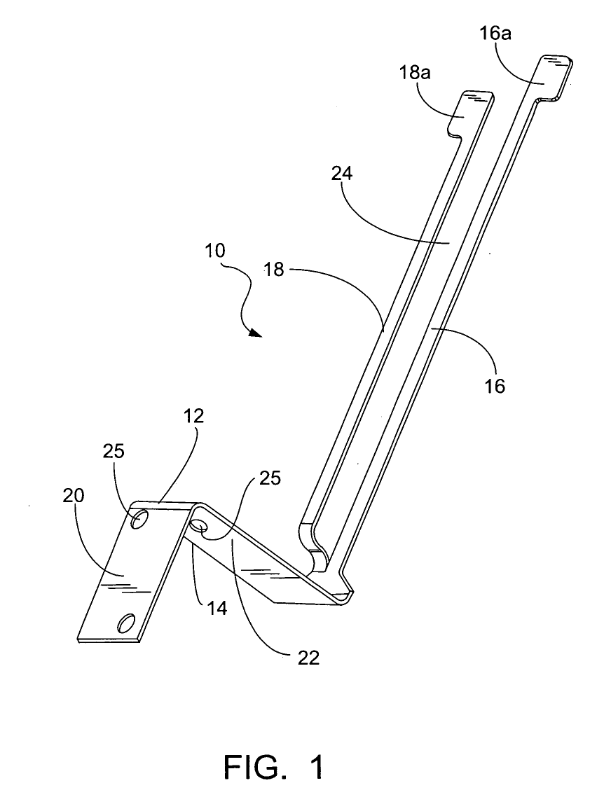

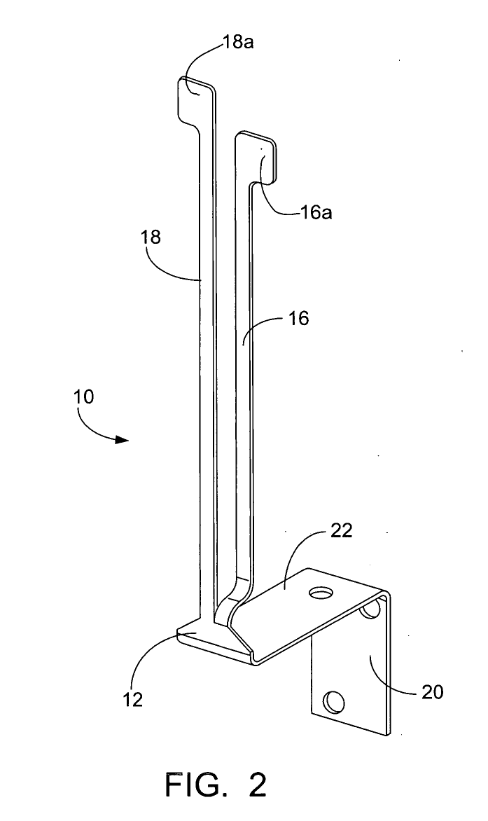

Referring now to FIGS. 1 and 2, the wiring clip of the present invention is shown. Wiring clip 10 includes an elongate metallic body 12 formed preferably of a suitable metal such as sheet metal, steel, pre-galvanized metals or equivalent. The material selected is sufficiently rigid so as to maintain the shape shown in FIGS. 1 and 2, but is sufficiently pliable to permit deformation thereof. The body 12 includes a mounting member 14 at one end thereof and a pair of elongate deformable fingers 16 and 18 extending therefrom. The mounting member 14 includes a generally L-shaped configuration having a planar base portion 20 and a planar extending portion 22 which is positioned generally perpendicular thereto.

As will be described in further detail hereinbelow, the planar base portion 20 is designed for placement on the face of a stud while the extending portion 22 is designed for positioning against the side of the stud. Each of the base portion and extending portion 20 and 22 may include apertures 25 therethrough for accommodating securement hardware which will be described in further detail below to secure the clip 10 to the stud.

As shown in FIGS. 1 and 2, fingers 16 and 18 are elongate members formed of thinned sections of the metallic body 12. The fingers are positioned in side-by-side arrangement with one finger 18 being raised from the plane of the other finger 16. This provides a channel 24 therebetween. As will be described in further detail hereinbelow, the channel 24 accommodates therein electrical wires and cables. The distal ends of fingers 16 and 18 include enlarged tabs 16a and 18a respectively. As will be described in further detail hereinbelow, the tabs 16a and 18a provide finger grips to permit manual deformation of the fingers 16 and 18.

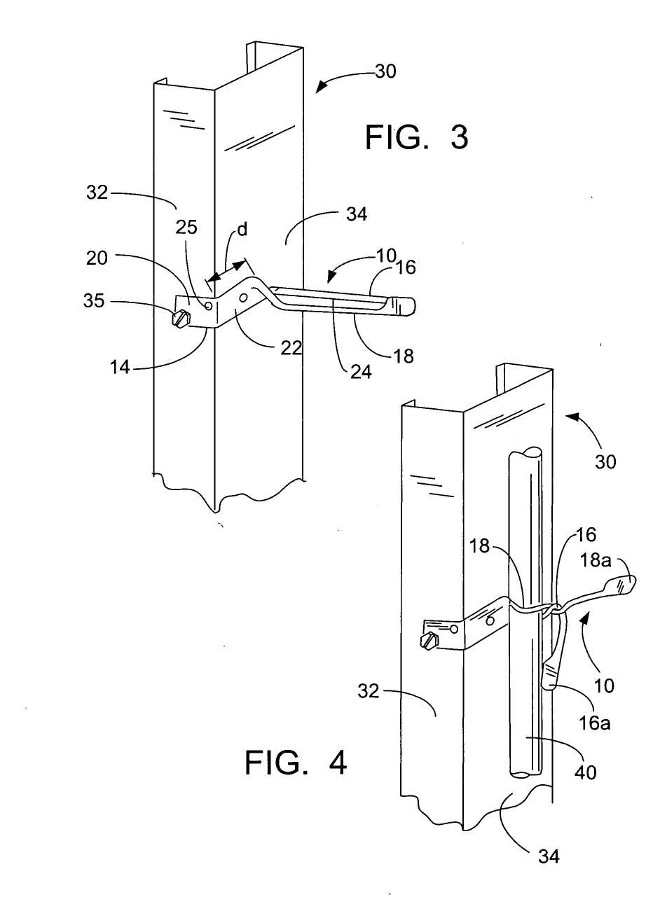

Having described the structure of the clip of the present invention, its use in securing wires and cables to building studs may now be described with reference with FIGS. 3 and 4.

As shown in FIG. 3, the wiring clip 10 of the present invention may be secured to a building stud 30. In the present illustrative example, building stud 30 is a conventional metal stud. However, it may be appreciated that the present invention may also be used with wood studs. As is well known, stud 30 is a generally rectangular member having a front face 32 and a perpendicular side 34. Front face 32 is used to support wall board thereto.

Wiring clip 10 is secured to stud 30 by placing the mounting member 14 against the stud. As shown in FIG. 3, the planar base portion 20 is supported along the face 32 of stud 30 while the extending portion 22 extends partially along the side 34 of stud 30. The wiring clip 10 is positionally secured to stud 30 by use of securement hardware such as screws 35 which extend through apertures 25 in face portion 20 and extending portion 22.

Due to the length of extending portion 22, the extending deformable fingers 16 and 18 extend at a fixed distance D from the face of stud 32. This fixed distance, which may be dictated by applicable codes, is the distance considered generally sufficient to prevent inadvertent contact with securement hardware used to secure the wall board to the stud or other items secured to the wallboard intermediate the studs.

As particularly shown in FIG. 4, a cable 40 may be placed within the channel 24 (FIG. 3) defined between fingers 16 and 18. When so positioned, the distal ends of the fingers 16 and 18 may be twisted about each other in a manner shown in FIG. 4 to secure the cable 40 therebetween. The tabs 16a and 18a may be used as finger grips to permit the twisting of the fingers 16 and 18. As the wire clip is formed of deformable metal, the fingers 16 and 18 are easily twistable around the cable 40. However, due to the metal construction and as a result of the structure not having elastic memory, the fingers will remain in the twisted condition securely placing the cable 40 at a location spaced from the face of the stud 32. While one cable 40 is shown, it can be appreciated that multiple wires, cables and the like may be supported by the wiring clip of the present invention.

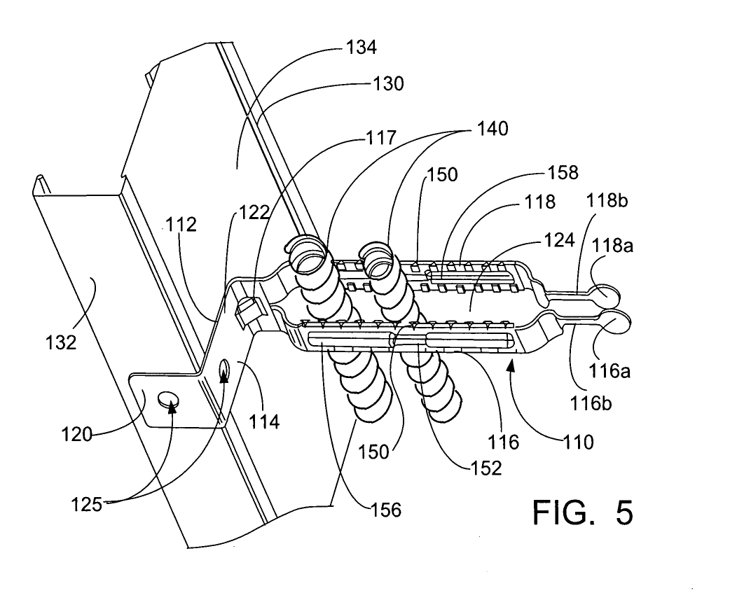

Referring now to FIG. 5, wiring clip 110 is shown. Wiring clip 110 is substantially similar to wiring clip 10 shown above and may be formed of similar materials. Wiring clip 110 includes a body 112 having a mounting member 114 at one end and a pair of elongate deformable fingers 116 and 118 extending therefrom. The mounting member 114 includes a generally L-shaped configuration having a planar base portion 120 and a planar extending portion 122 which is positioned generally perpendicular thereto. The planar base portion 120 is designed for placement on the face 132 of a stud 130 while the extending portion 122 is designed for positioning along the side 134 of the stud 130. Each of the base portion and the extending portion 120 and 122 may include apertures 125 therethrough for accommodating securement hardware such as screws which secure the wiring clip to the stud 130.

As shown in FIG. 9, the aperture 125 on extending portion 122 may include a forwardly opening covering or shroud 129. This allows the opening to be forward facing. Thus, an installer can install fastening hardware therethrough from a forward angled direction.

As shown in FIG. 5, mounting member 114 includes a brace 117 at a location at one end of planar extending portion 122 at the junction with fingers 116 and 118. The brace 117 prevents over bending of the fingers thereat.

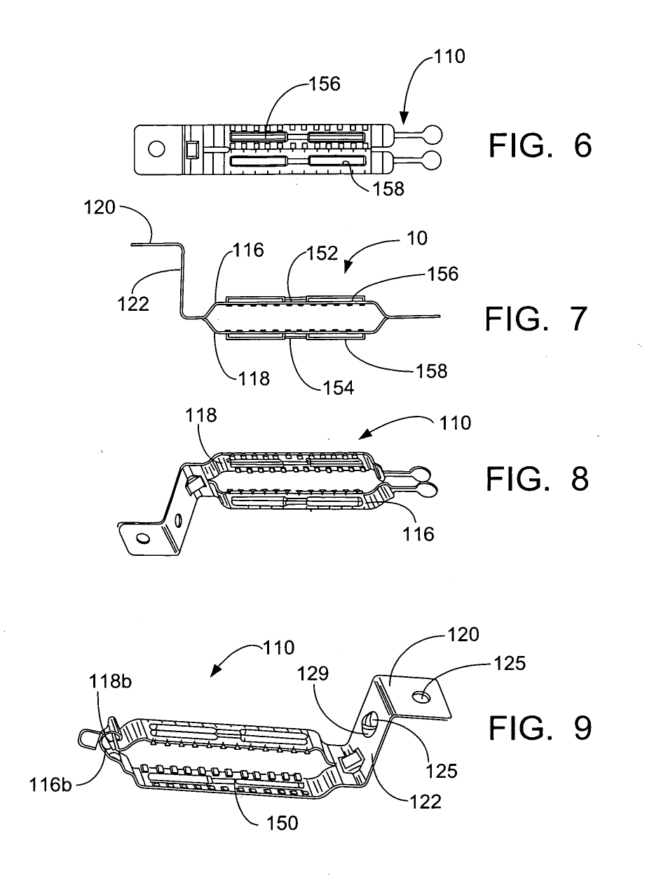

As additionally shown in FIGS. 6-9, fingers 116 and 118 are elongate generally planar members positioned in offset side-by-side arrangement with one finger 118 being raised from the plane of the other finger 116. This defines a channel 124 therebetween for supporting, as shown in this embodiment, a plurality of armored cable conduits 140.

In order to assist in the support and securement of the cable conduits 140, fingers 116 and 118 include a plurality of longitudinally extending inwardly directed rigid protrusions 150. These protrusions serve to frictionally retain the armored cable conduit 140 preventing excessive movement thereof.

The fingers 116 and 118 further include at distal ends thereof finger extensions 116b and 118b, respectively, which terminate with finger grip tabs 116a and 118a. The extensions 116b and 118b are narrowed portions of the fingers which define a twisting area which facilitate twisting the extensions together so as to secure the armored cable conduit 140 therebetween. The finger grips tabs 116a and 118a assist in the twisting of the extensions at the twisting area. The twisting of the extensions 116b and 118b at the twisting area is more fully shown in FIG. 9. The twisting together of the fingers at the extensions is sufficient to maintain the armored cable in position between the fingers 116 and 118 as the rigid protrusions 150 help maintain the cable conduit therein.

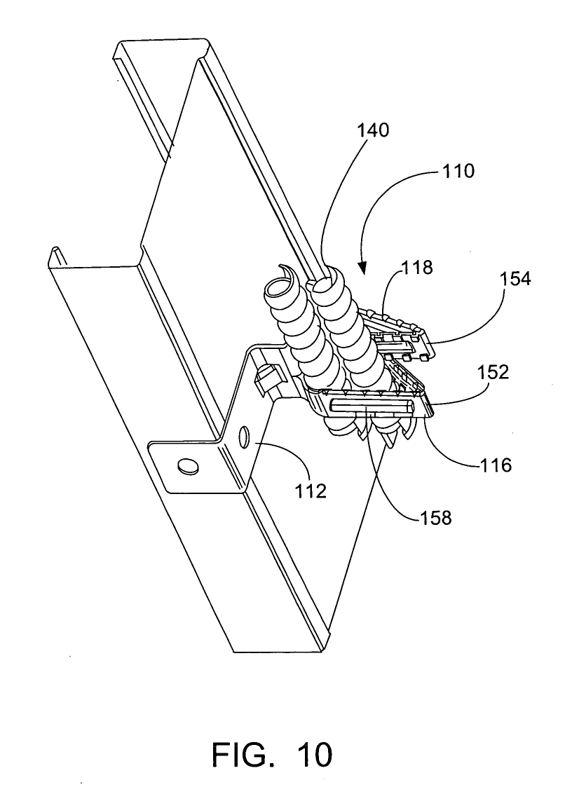

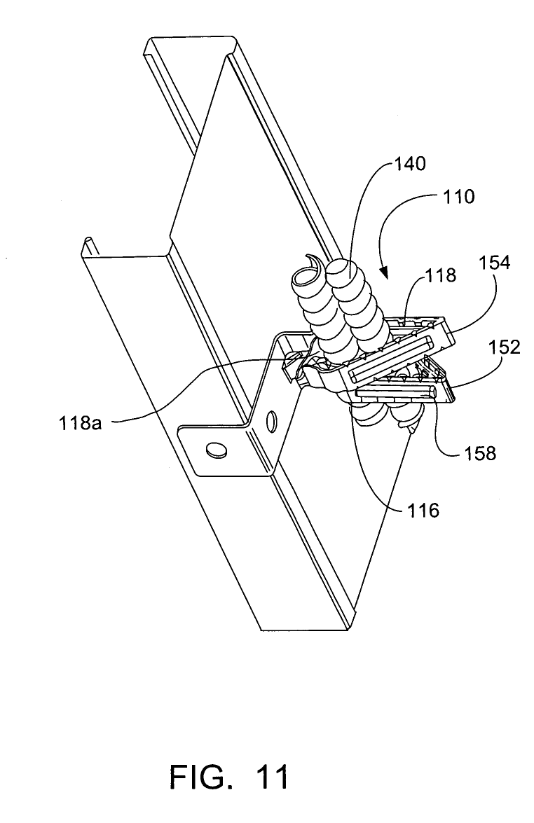

In addition to securing the cable conduit by manually twisting the twisting area defined by extensions 116b and 118b, the present invention also provides support for the armored cable conduit 140 by longitudinally bending the fingers 116 and 118 as shown in FIGS. 10 and 11. In order to facilitate such bending, each finger 116 and 118 is provided with a midpoint bending recess 152 and 154. The bending recesses are defined between strengthening ribs 156 and 158 (FIG. 7) which extend from the surface of planar fingers 116 and 118. The strengthening ribs 156 and 158 are elongate members with the recesses 152 and 154 being centrally located.

As shown in FIGS. 7, 10 and 11, the arrangement of the strengthening ribs 156 and 158 with the midpoint bending recess being positioned at a central location therealong facilitates the bending or folding of the fingers 116 and 118 thereat and about the conduits 140. The fingers 116 and 118 may be bent either in the same direction as shown in FIG. 10, or in opposite directions as shown in FIG. 11. The finger extensions 116b and 118b as well as the tabs 116a and 118b may be further bent inwardly as shown in FIG. 11 to further secure the conduit 140 therein.

A further and preferred embodiment of the present invention is further shown herein.

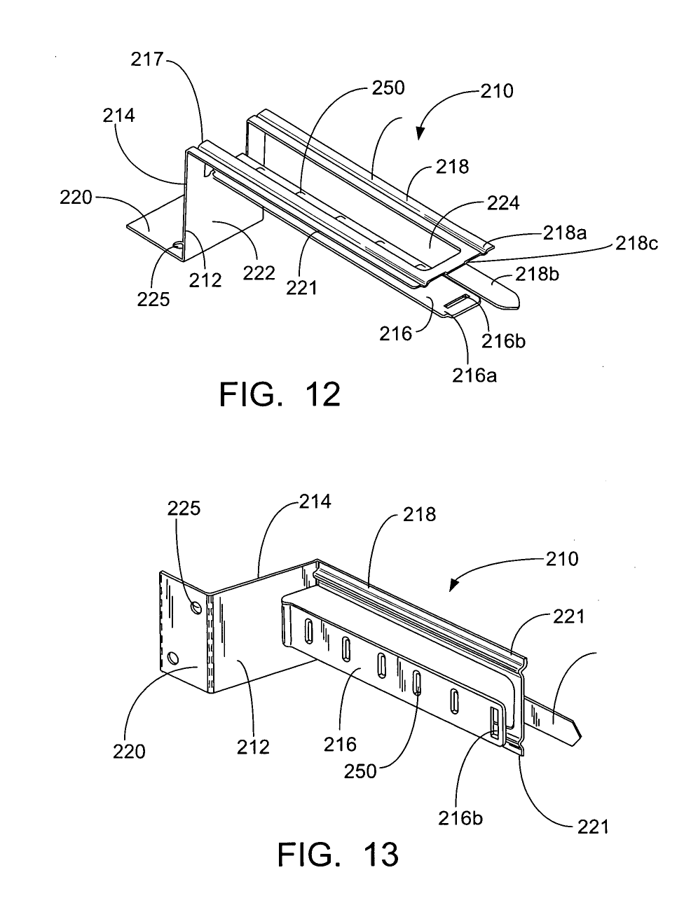

Referring now to FIGS. 12 and 13, wiring clip 210 is shown. Wiring clip 210 includes a body 212 having a mounting member 214 at one end and a pair of elongate fingers 216 and 218 extending therefrom. Mounting member 214 includes a generally L-shaped configuration having a planar base portion 220 and a planar extending portion 222 which is positioned generally perpendicular thereto. The planar base portion 220 is designed for placement on the face of the stud while the extending portion 222 is designed for positioning along the side of a stud in a manner similar to that shown in FIGS. 3 and 5 hereinabove. Each of the base portion 220 and the extending portion 222 may include apertures 225 therethrough for accommodating securement hardware such as screws (not shown) which secure the clip 210 to the stud.

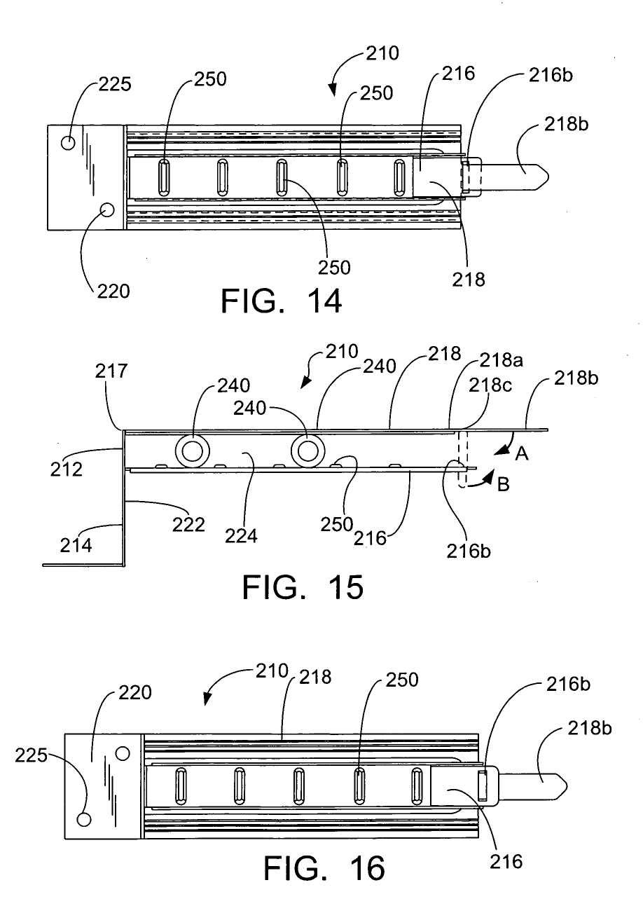

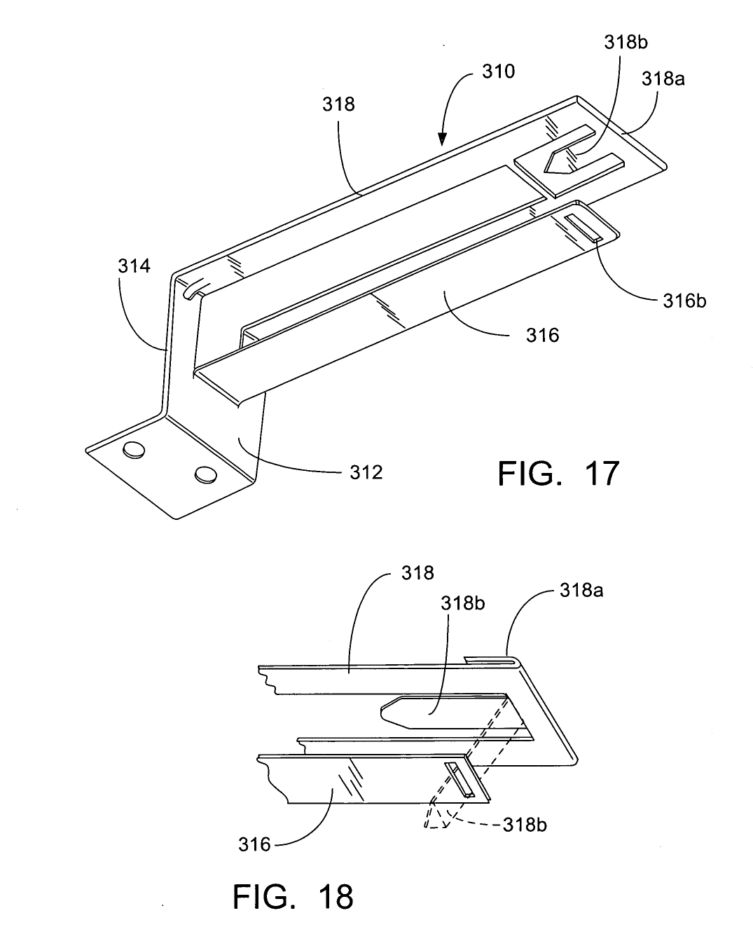

As shown additionally in FIGS. 14-16, fingers 216 and 218 are elongate generally planar members positioned in an offset side-by-side arrangement so that the fingers extend parallel to one another with one finger 218 being raised from the plane of the other finger 216. In a preferred construction, finger 216 may be formed or struck from the material removed from the central portion of finger 218. The parallel fingers 216 and 218 define a channel 224 therebetween for supporting cable in a manner similar to that shown in FIG. 5 hereinabove.

In order to assist in supporting and positionally confining the cable in channel 224, finger 216 includes a plurality of longitudinally spaced inwardly directed protrusions 250. The protrusions 250 serve to frictionally retain cable 240 within the channel 224 preventing excessive movement therein.

Fingers 216 and 218 extend from a proximal location 217 adjacent extending portion 222 of mounting member 214. The fingers 216 and 218 include distal extents 216a and 218a respectively at ends opposite location 217. End extent 218a of finger 218 includes a distally extending tab 218b. Tab 218b is deformable about a fold line 218c at the connection of the tab 218b to the end extent 218a of FIG. 218. Finger 216 includes at its distal extent 216a a slot 216b extending therethrough. Slot 216b is sized to accommodate insertably therethrough the tab 218b of finger 218 when it is folded downwardly towards finger 216 as shown by arrow A in FIG. 15. The slot 216b is generally positioned in alignment with the distal extent 218a of finger 218 so that when the tab 218b is bent downwardly in a position perpendicular to finger 218 it will be directly insertable into slot 216b. The furthermost end of tab 218b can be further bent about slot 216b in the direction of arrow B to secure the tab therein. The insertion of tab 218b into slot 216b as well as the subsequent bending serves to retain the two fingers together and secure cables 240 placed within channel 224 therebetween.

In order to assure the rigidity of the fingers and securement of the cables 240 within channel 224, finger 218 includes rounded longitudinal edges 221. These edges 221 provide longitudinal rigidity to the finger.

A further variation of the wiring clip of FIGS. 12 and 13 is shown in FIGS. 18 and 19.

Wiring clip 310 is substantially similar to wiring clip 210 shown above including a body 312 having a mounting member 314 at one end and pair of fingers 316 and 318 extending distally therefrom. In this embodiment, the tab 318b is formed at the distal end of finger 318. The tab 318b is formed to extend from a distal transverse edge 318a and is directed back towards mounting member 314.

In a similar manner, the tab 318b may be bent downwardly towards finger 316 so it is insertable into slot 316b of finger 316. In all other respects, the wiring clip 310 performs substantially similar to wiring clip 210 described above.

As shown in FIG. 19, the distal end 318a of finger 318 may be rolled back upon itself to provide additional structural rigidity to finger 318.

Various changes to the foregoing described and shown structures would now be evident to those skilled in the art. Accordingly, the particularly disclosed scope of the invention is set forth in the following claims.

What is claimed is:

1. A clip for supporting an electrical cable to a stud comprising:
an elongate metallic body having a mounting member at one end for attachment to said stud and a pair of elongate deformable fingers extending outwardly therefrom;
said fingers defining a channel therebetween for accommodating said cable;
said fingers having end extents which are twistable about one another to secure said cable in said channel.

2. A clip of claim 1 wherein said mounting member is an L-shaped bracket having a first portion for engagement with a face of the stud and a second portion perpendicular thereto extending along a side of the stud.

3. A clip of claim 1 wherein said fingers extend perpendicularly from said second portion at one end thereof.

4. A clip of claim 1 wherein said end extents of said fingers include tabs thereat.

5. A clip of claim 1 wherein said fingers are arranged in different planes.

6. A clip of claim 1 wherein said fingers include a bending location at about a midpoint along the length thereof.

7. A clip of claim 6 wherein said fingers include frictional protrusions therealong for supporting said cable.

8. A clip of claim 1 wherein said fingers each include thinned extension portions extending distally therefrom defining said end extents, wherein said extension portions define a twisting area.

9. A clip of claim 3 wherein said body includes a ridge brace at a location adjacent said end of said second portion.

10. A clip of claim 6 wherein said fingers include a strengthened rib on either side of said bending locations.

11. A wiring clip comprising:
an L-shaped base for mounting to a stud;
a pair of spaced apart bendable finders extending from said based, said fingers defining a channel therebetween for supporting wire therein;
said fingers being offset so that said bendable fingers can be bent about said wire.

12. A wiring clip of claim 11 wherein each said finger includes a planar surface.

13. A wiring clip of claim 12 wherein each said finger includes a stiffening rib extending from said planar surfaces.

14. A wiring clip of claim 13 wherein each said finger includes a recess within said stiffening ribs so as to define a bending location.

15. A wiring clip of claim 11 wherein each said finger includes a finger extension extending from a distal end thereof, said finger extension being detachable with respect to said finger.

16. A wiring clip for supporting an electrical cable to a stud comprising:
an elongate metallic body having a mounting member at one end for attachment to said stud and a pair of generally parallel fingers extending outwardly therefrom;
said fingers defining a channel therebetween for accommodating said cable; and
said fingers including distal end extents which are place in mutual engagement to secure said cable in said channel.

17. A wiring clip of claim 16 wherein said end extent of one of said fingers includes a deformable extending tab for engagement with said end extent of said other finger.

18. A wiring clip of claim 17 wherein said other end extent includes a slot for receiving said deformable extending tab of said one end extent.

19. A wiring clip of claim 18 wherein said deformable tab extends distally from said end extent of said one finger.

20. A wiring clip of claim 16 wherein said fingers are generally flat planar members.

21. A wiring clip of claim 20 wherein at least one of said fingers includes a plurality of spaced apart frictional protrusions for supporting said cable.

22. A wiring clip of claim 16 wherein said body is integrally formed.

23. A wiring clip of claim 16 wherein said mounting member is an L-shaped bracket having a first portion for engagement with a face of said stud and a second portion perpendicular thereto extending along a side of said stud.

24. A wiring clip of claim 23 wherein said fingers extend from said second portion of said mounting member.
